(19) United States
(12) Patent Application Publication
(10) Pub. No.: US 2021/0261332 A1
(43) Pub. Date: Aug. 26, 2021

(54) INTER-LEVEL TRANSFER LIFT SYSTEM AND METHOD

(71) Applicant: Dematic Corp., Grand Rapids, MI (US)

(72) Inventor: Jeffrey M. Jacobs, New Berlin, WI (US)

(21) Appl. No.: 17/185,446

(22) Filed: Feb. 25, 2021

Related U.S. Application Data
(60) Provisional application No. 62/981,229, filed on Feb. 25, 2020.

(51) Int. Cl. B65G 1/04; B65G 1/06

(52) U.S. Cl. CPC B65G 1/0492; B65G 1/06

(57) ABSTRACT

A method and system for storing items into and retrieving items from an automated storage facility. The system includes an inbound drop conveyor, an infeed lift, and an infeed rack conveyor at each level of a storage rack, all dedicated to store items into the storage rack. The system includes an outbound pick conveyor, an outfeed lift, and an outfeed rack conveyor at each level of the storage rack, all dedicated to retrieve items from the storage rack. The inbound drop conveyor and the outbound pick conveyor may be disposed at different rack levels. The method is particularly well suited for transferring items between disparate locations within the facility and the system includes an inter-level transfer system to transfer items between disparate locations within the storage facility.

### CROSS REFERENCE TO RELATED APPLICATION

The present application claims priority of U.S. provisional application Ser. No. 62/981,229 filed Feb. 25, 2020, which is hereby incorporated herein by reference in its entirety.

### FIELD OF THE INVENTION

The present invention is directed to lift systems for an automated warehouse storage system, and particularly to an automated warehouse having a dedicated lift for item storage and a dedicated lift for item retrieval.

### BACKGROUND OF THE INVENTION

Order fulfillment of orders placed over the Internet must take place within a relatively short period of time in order to be commercially competitive. The same could be said for orders received by phone, facsimile, or by the mail based on catalog or television-based merchandising. Such order fulfillment is known as E-commerce and places demands on an order fulfillment system to meet such obligations. This is compounded by the fact that E-commerce usually involves a large number of small orders (each containing as few as one item in the order) that are selected from an inventory with a large number of potential items. Inefficiencies and conflicts arise in warehouses due to the size constraints associated with warehousing and transporting items for order fulfilment, such as the amount of equipment or personnel required to carry out an order fulfilment process, the size of the equipment involved, the size of the items to be manipulated, and other factors. Additional inefficiencies and conflicts arise in sequencing orders and compiling items for orders having multiple items. Efficiencies of item transportation and space usage often dictate the layout of storage facilities and the direction of travel of items within the storage facility.

### SUMMARY OF THE INVENTION

The present invention provides a system and methods for storing items into and retrieving items from an automated warehouse storage facility and for transferring items stored in one portion of the storage facility to another portion of the storage facility via an inter-level transfer lift system in an automated warehouse storage facility. The method is particularly useful for transferring items between portions of a storage facility when those portions are not in direct transport communication such that multiple transportation components, such as multiple conveyors, multiple shuttles, and multiple lifts, are required to transfer an item from one location to another location within the facility. In typical operation, the conveyors within the storage facility are configured for operation in a single direction, including buffer conveyors and lift platform conveyors. Bi-directional transportation with conveyors can create conflicts within the system that may reduce efficiency and through-put.

In one form of the present invention, a method is provided for storing goods into and retrieving goods from an automated warehouse storage facility having a plurality of storage rack levels. The storage facility may include an inter-level transfer system that is adapted to transfer an item from one item storage location of a storage facility to another location of the storage facility. For example, transferring an item from an initial storage location to a destination storage rack level at another portion of the storage facility or to an outbound transportation system. The method is particularly well-suited for storage rack systems that include an item infeed conveyor for inducting goods to an infeed lift and an outfeed conveyor for retrieving goods from an outfeed lift wherein the infeed and outfeed conveyors are positioned at different rack levels and wherein the infeed lift and outfeed lift are uni-directional, i.e. each of the infeed and outfeed conveyors are configured to move items in only one respective horizontal direction. The infeed lift transfers items to a particular storage rack level after receiving items from the infeed conveyor. The infeed conveyor is positioned adjacent to the infeed lift and the outfeed conveyor is positioned adjacent to the outfeed lift.

The method includes determining if an item is to be stored into the storage facility or retrieved from the storage facility. If the item is to be stored into the facility, delivering the item to an infeed conveyor with an inbound transportation system in direct transport communication with the infeed conveyor. Then transferring the item from the infeed conveyor to the infeed lift and then moving and transferring the item with the infeed lift to a particular storage rack level to be stored at a required item storage location in that particular level. If the item is to be retrieved from an item storage location within the storage facility, retrieving the item from the item's storage location and transporting the item to the outfeed lift. Then the method includes moving and transferring the item with the outfeed lift to the outfeed conveyor and transferring the item from the outfeed conveyor to an outbound transportation system that is in direct transport communication with the outfeed conveyor.

In one aspect, the method further includes retrieving the item from its item storage location with a shuttle for retrieving items from any item storage location within the storage rack level corresponding to the shuttle. The method includes transporting the item with the shuttle to a buffer conveyor adjacent to the outfeed lift and buffering the item until the outfeed lift is ready to retrieve the item. When the outfeed lift is ready, retrieving the item with the outfeed lift from the buffer conveyor and transporting or moving the item to the required location. If the item is required at a storage location that is not serviceable by the outfeed lift, the method further includes transporting the item to another lift that is in direct transport communication with the required storage location.

In another form of the present invention, a method is provided for transporting goods from a particular item storage location in a storage rack of an automated warehouse storage facility to another location in the storage facility that requires an item from that particular storage location. The particular item storage location and the other location may or may not be in direct transport communication with each another. As such, an inter-level transfer of the required item is required to transport the required item from the particular item storage location to the other location. The method includes determining if a required item that is stored at a particular storage location in a particular portion of a storage rack is serviceable by a shuttle and a lift that are in direct transport communication with each other and/or determining whether the lift is in direct transport communication with a particular transportation system that requires the required item. If it is determined that the item storage location of the required item is serviceable by the lift corresponding to the particular transportation system that requires the required item, the method includes retrieving the required item with a shuttle from the particular storage location and transporting the required item with that shuttle to the lift corresponding to the particular transportation system that requires the required item. Then transporting or lifting the required item from that lift and transferring the required item to the particular transportation system that requires the required item.

If it is determined that the required item is not serviceable by the lift corresponding to the particular transportation system that requires the required item, the method includes performing an inter-level transfer with an inter-level transfer system. Performing an inter-level transfer includes retrieving the required item with an initial shuttle from the particular storage location and transferring the required item from the initial shuttle to an initial lift that is in direct transport communication with the initial shuttle. The method includes transporting the required item with the initial lift to an intermediate shuttle that is configured to service both the initial lift and a required lift that is in direct transport communication with the particular transportation system that requires the required item. The intermediate shuttle is operating at a different level of the storage facility than the initial shuttle. The method then includes transporting the required item with the intermediate shuttle to the required lift and transferring the required item from the intermediate shuttle to that required lift. Then transporting and transferring the item with that required lift to the particular transportation system that requires the required item.

In still another form of the present invention, a method is provided for transferring goods with an inter-level transfer system from one disparate level of a storage rack to another disparate level of the storage rack. The method is particularly useful for transferring an item from a particular item storage location of a disparate storage rack level in one portion of a storage rack to another disparate storage rack level within a different portion of the storage rack system. For example, for transferring an item from one basement level of a storage rack to a different basement level of the storage rack wherein the basement levels are horizontally separated by an empty or open portion of the storage rack. The method includes retrieving an item from an initial disparate level of a first storage rack that is serviceable by a first lift located adjacent to the first storage rack, transporting the item from the initial level to the first lift and then transferring the item with the first lift to an intermediate level of the storage rack. The intermediate level is located at an intermediate or central portion of the storage rack. The intermediate level is configured to transfer an item from the first lift to a second lift located at an opposite side of the intermediate portion from the first portion of the storage rack. The method includes transporting and transferring the item through the intermediate level from the first lift to the second lift. The second lift then transferring or lifting the item to a disparate destination level of a second portion of the storage rack which is located adjacent to the second lift. The method is particularly useful in circumstances when the first storage rack is not directly serviceable by the second lift (e.g. a particular shuttle cannot access each of the first storage rack and the second lift) and the second storage rack is not directly serviceable by the first lift (e.g. a particular shuttle cannot access each of the second storage rack and the first lift). In other words, the first and second storage racks are disparate from one another.

In yet another form of the present invention, an automated warehouse storage facility is provided for transferring items from an initial storage location in one portion of a storage facility to another location in a different portion of the storage facility and the initial storage location and the other location are not in direct transport communication with each other. The storage facility includes a storage rack module defined by a plurality of levels each including a plurality of item storage locations. The storage rack module having a first side storage rack, a second side storage rack spaced apart from the first side storage rack, and an aisle disposed at each level between the first and second storage racks. A shuttle is disposed in the aisle of each level and each of the shuttles is operable to service each of the item storage locations of the level corresponding to the shuttle. The storage facility includes a pair of lifts disposed adjacent to the storage rack module. The pair of lifts including an infeed lift for inputting items into the storage rack module and an outfeed lift for retrieving items from the storage rack module. The infeed lift is positioned adjacent to the first side storage rack and the outfeed lift is positioned adjacent to the second side storage rack. The inter-level transfer system includes an infeed rack conveyor at each level of the first side storage rack between the first side storage rack and the infeed lift. Each of the infeed rack conveyors is provided to receive items from the infeed lift and to buffer the items until the shuttle disposed in the aisle of the respective level is available to retrieve the item. An outfeed rack conveyor is provided at each level of the second side storage rack between the second side storage rack and the outfeed lift. Each of the outfeed rack conveyors is provided to receive items from the shuttle disposed in the aisle of the respective level and to buffer the items until the outfeed lift is available to retrieve the item. The infeed rack conveyors and the outfeed rack conveyors are each operable to transport items in only one horizontal direction. The infeed rack conveyor and the shuttle disposed at each level cooperate with the infeed lift to input items into the storage rack module. The outfeed rack conveyor and the shuttle disposed at each level cooperate with the outfeed lift to retrieve items from the storage rack module.

In one aspect, the storage facility includes an infeed drop conveyor adjacent to the infeed lift to transfer items from an inbound transportation system to the infeed lift. The inter-level transfer system may further include an outfeed pick conveyor adjacent to the outfeed lift to transfer items from the outfeed lift to an outbound transportation system. The infeed drop conveyor is located vertically corresponding to one of the levels of the storage rack module and the outfeed pick conveyor is located vertically corresponding to a different one of the levels of the storage rack module such that the infeed drop conveyor and the outfeed pick conveyor are vertically offset from one another by at least one level of the storage rack module.

Therefore, the present invention provides a method and system to transfer items within an automated warehouse storage facility when an item required at a particular location within the facility is not directly serviceable by transportation components that directly service the particular location of the required item. The system includes an inbound drop conveyor, an infeed lift, and an infeed rack conveyor disposed at each level of the storage rack, all cooperating to input items into the storage rack, such as when items are received into the storage facility. The system includes an outbound pick conveyor, an outfeed lift, and an outfeed rack conveyor disposed at each level of the storage rack, all cooperating to retrieve items from the storage rack, such as when an item in the storage rack is required to fulfil an order. The system also includes transfer conveyors disposed at particular levels of the storage racks and the transfer conveyors cooperate with the outfeed lifts to transfer items from one portion of the storage facility to another portion of the storage facility to enable efficient transport of items to required locations in the storage facility.

These and other objects, advantages, purposes, and features of the present invention will become more apparent upon review of the following specification in conjunction with the drawings.

### BRIEF DESCRIPTION OF THE DRAWINGS

FIG. 1 is a diagram of a method for operating an automated warehouse storage facility in accordance with the present invention;

FIG. 2 is a diagram of another method for operating an automated warehouse storage facility in accordance with the present invention;

FIG. 3 is a diagram of yet another method for operating an automated warehouse storage facility in accordance with the present invention;

FIG. 4 is a perspective view of an inter-level transfer system for a storage facility, in accordance with the present invention;

FIG. 5 is an enlarged perspective view of a lift and a buffer portion of the inter-level transfer system of FIG. 4;

FIG. 6 is another enlarged perspective view of the lift and the buffer portion of the inter-level transfer system of FIG. 4;

FIG. 7 is an enlarged plan view of the lift and the buffer portion of the inter-level transfer system of FIG. 4;

FIG. 8 is an enlarged plan view of the lift and the buffer portion of a standard level of the storage rack of FIG. 4;

FIG. 9 is an enlarged plan view of the lift and the buffer portion of a transfer level of the storage rack of FIG. 4;

FIG. 10 is an enlarged plan view of the lift and the buffer portion of a basement level of the storage rack of FIG. 4;

FIG. 11 is yet another enlarged perspective view of the lift and the buffer portion of the inter-level transfer system of FIG. 4;

FIG. 12 is a plan view of a plurality of adjacent storage racks in a storage facility, each storage rack including inter-level transfer systems in accordance with the present invention;

FIG. 13 is a sectional view of an outfeed lift and transfer portion of a storage rack;

FIG. 14 is a sectional view of a infeed lift and transfer portion of a storage rack; and

FIG. 15 is an enlarged plan view of a lift and a buffer portion of a storage rack including an infeed drop conveyor and an outfeed pick conveyor, in accordance with the present invention.

### DETAILED DESCRIPTION OF THE PREFERRED EMBODIMENT

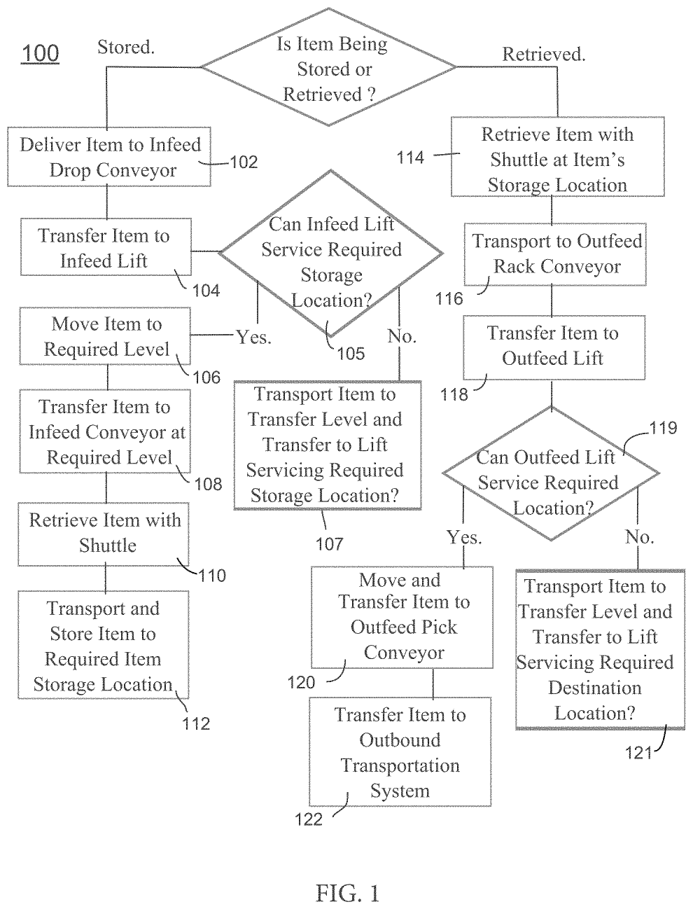

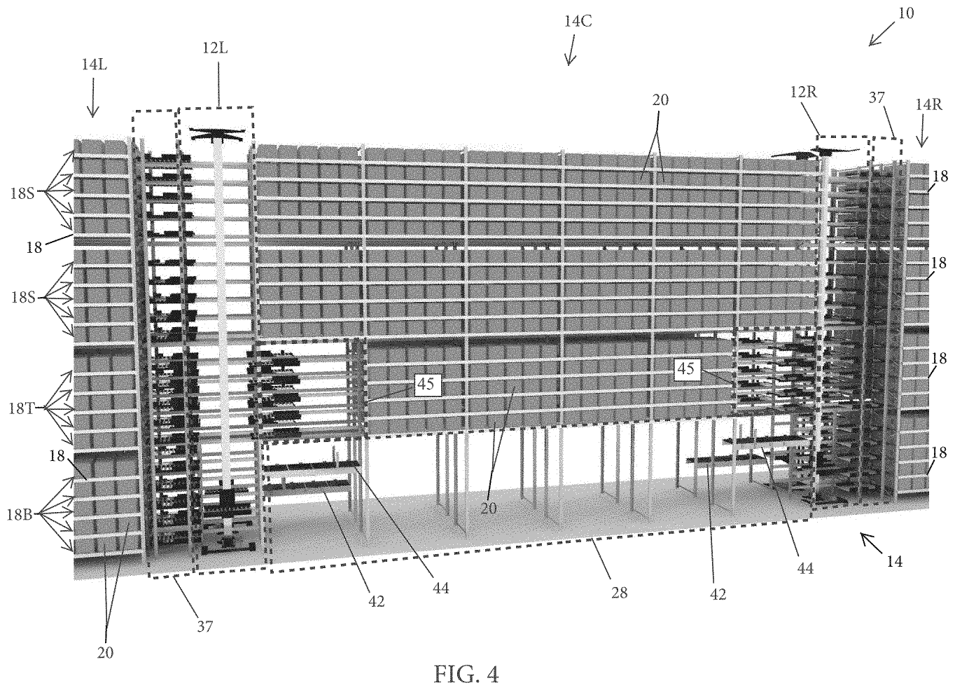

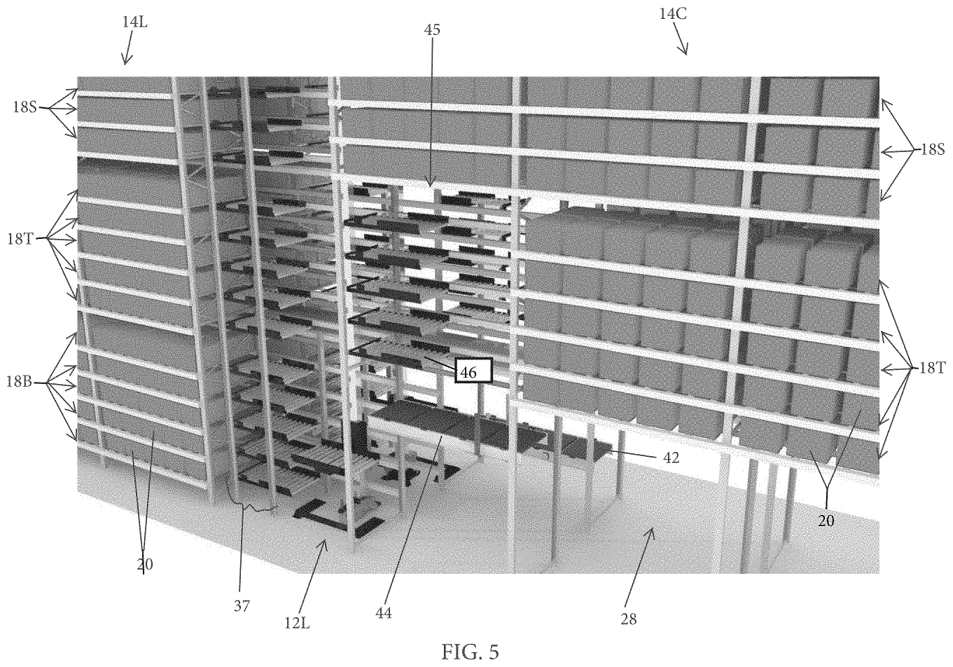

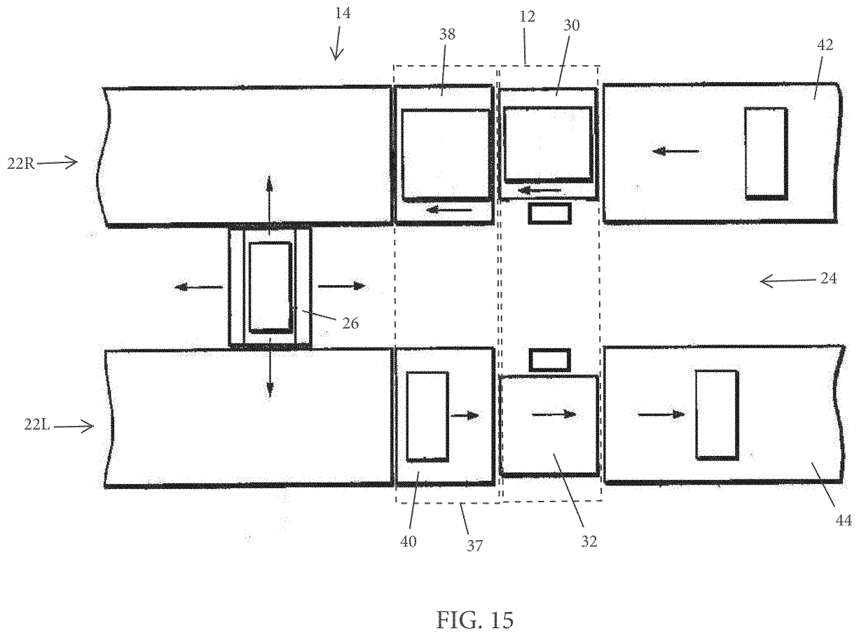

Referring now to the drawings and the illustrative embodiments depicted therein, a methods are provided for operating an automated warehouse storage facility 10 wherein a storage rack system 14 is serviced by an inter-level transfer lift system 12 (FIGS. 1-15). The automated warehouse storage facility may be similar to that described in commonly assigned U.S. Pat. No. 9,266,675, which issued on Feb. 23, 2016, which is hereby incorporated herein by reference, in its entirety. In the illustrated embodiment of FIGS. 4-15, the storage facility 10 includes a storage rack system 14 that includes a plurality of portions or modules within the rack system 14, including a left side storage rack module 14L, a right side storage rack module 14R, and a center or intermediate storage rack module 14C disposed between the left rack module 14L and the right rack module 14R. The storage facility includes a plurality of inter-level transfer lift systems 12, including a left side inter-level transfer lift system 12L disposed between the left rack module 14L and the intermediate rack module 14C and a right side inter-level transfer lift system 12R disposed between the intermediate rack module 14C and the right rack module 14R. The storage rack 14 includes a plurality of rack levels 18 which each include a plurality of item storage locations 20 along each level 18. The levels 18 may be subdivided into groups of levels, such as in groups of five levels with a maintenance level disposed between the groups of levels 18. In the illustrated embodiments, various conveyor components are provided within the storage facility 10 and the inter-level transfer lift system 12 to facilitate efficient movement of items within the facility (e.g. buffer conveyors, lift platform conveyors, and transfer conveyors). For conflict efficiency, it is preferable that each of the conveyor components are operated in only a single direction, as bi-directional transportation with conveyors may create conflicts within the system which may reduce efficiency and through-put. As such, it will be appreciated that bi-directional conveyor operation is limited or not used entirely within the inter-level transfer lift system.

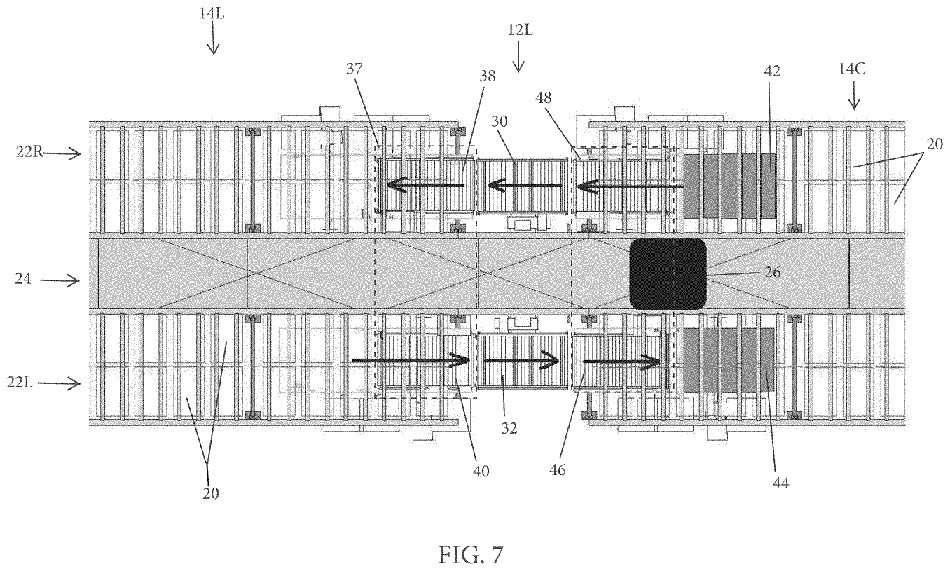

Each storage rack 14 includes a pair of spaced apart stacked racks including a left side stacked rack 22L and a right side stacked rack 22R (FIGS. 7-10). The left and right racks 22L, 22R are spaced apart from one another with the space between them defining an aisle 24. A shuttle 26 is operable within each aisle to service a corresponding level of the storage rack 14. The shuttle 26 moves horizontally along the length of the aisle 24 to service the item storage locations 20 along the entire length of the corresponding aisle 24. The shuttle 26 services both the right side rack 22R and the left side rack 22L of the respective level 18.

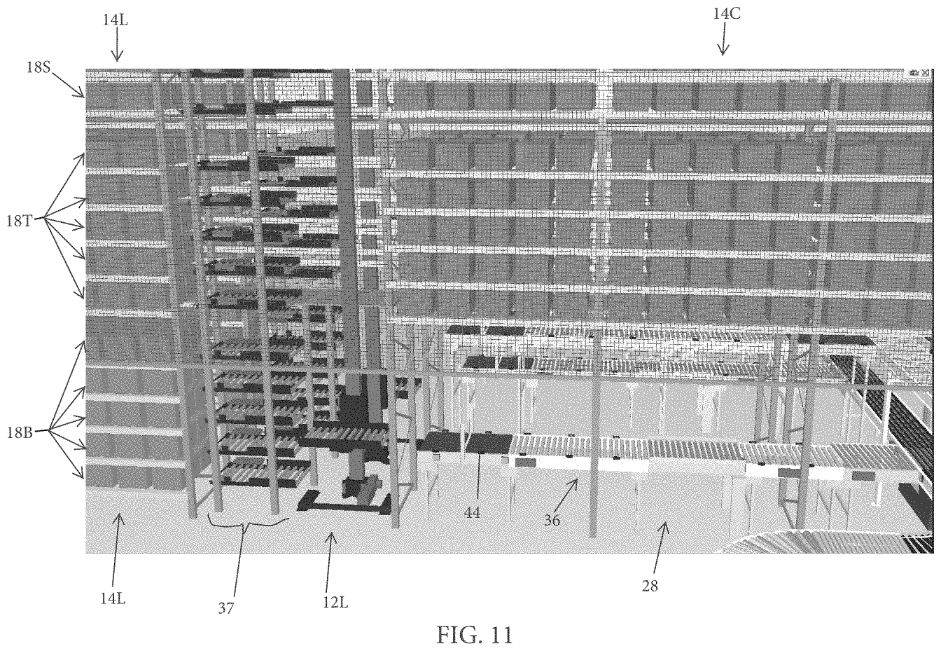

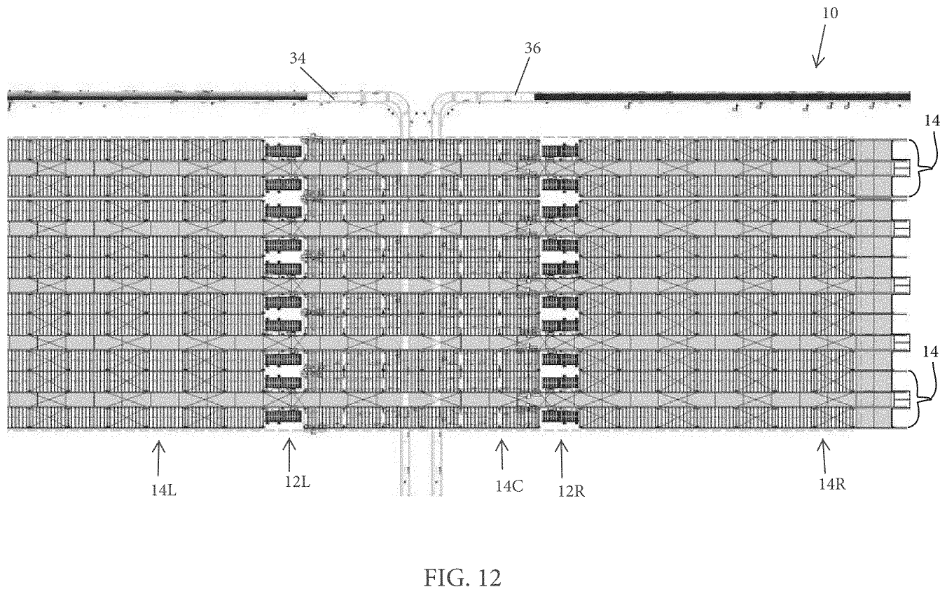

In the illustrated embodiment of FIGS. 4-12, the intermediate storage rack module 14C does not include any item storage locations 20 within a “basement” open area 28. The basement 28 may be completely empty, i.e. for personnel and equipment movement purposes (FIG. 4), or may include various conveyors and transportation elements, i.e. for transporting products to and from the racks 14 (FIGS. 11-12), such as from a receiving module or to a packing station. The basement 28 does not include item storage locations and corresponds in height to the bottom five levels 18B of the left and right storage racks 14L, 14R. Because the basement 28 does not include any aisles, shuttles, or item storage locations, the shuttles 26 disposed in the bottom five levels 18B of the left and right storage racks 14L, 14R are not able to pass through the basement 28. As such, the shuttles 26 in the bottom five levels 18b of racks 14L and 14R are disparate from one another (FIG. 4). In other words and as an example, it is not possible for the shuttles 26 in the bottom five levels 18B of the left rack module 14L to directly interact with the right side lift system 12R, and vice versa. Therefore, if an item stored in the item storage locations 20 of the bottom five levels 18B of the left module 14L is required at the right side lift system 12R, that item must be transferred to a different level, above the basement 28, to be transferred via a shuttle 26 (in a non-basement rack level) to the right side lift system 12R.

For purposes of this disclosure, the term “disparate” refers to a component that is not directly serviceable by or in direct transport communication with another component. For example, the inter-level transfer lift system 12R (as depicted in FIG. 4) is disposed between the intermediate storage rack 14C and the right side storage rack 14R and is disparate from the shuttles 26 operating in the bottom five levels 18B of the left side storage rack 14L because those shuttles cannot directly access or service the right side inter-level transfer lift system 12R. In this embodiment, the shuttles 26 operating in the bottom five levels 18B of storage racks 14L and 14R are disparate from one another because each shuttle 26 is not able to pass from storage rack 14L through the basement 28 to the other storage rack 14R. “Direct transport communication” defines a relationship between two components of the storage facility 12, wherein an item is directly transportable between the two defined components. For example a shuttle 26 is in direct transport communication with a lift system 12 if the shuttle 26 can travel adjacent to that lift system 12, or a lift system 12 is in direct transport communication with a particular portion of a storage rack 14 if the lift system 12 can travel adjacent to a level 18 of that portion of the storage rack 14. As an example of an instance where two components of the storage facility 10 are not in direct transport communication (see FIG. 4), a shuttle 26 operating in one of the bottom five levels 18B of the left module 14L is not in direct transport communication with the right side lift system 12R.

As best shown in FIGS. 7-10, each inter-level transfer lift system 12 includes a pair of adjacent lifts for either inputting items into the storage rack 14 or retrieving an item from the storage rack 14. The pair of adjacent lifts include an infeed lift 30 adapted to receive an item from an inbound transportation system and to lift and/or transfer the item into a level 18 of a corresponding storage rack 14 and an outfeed lift 32 adapted to receive an item from a level 18 of a corresponding storage rack 14 and to lift and/or transfer the item to an outbound transportation system. In the illustrated embodiment of FIGS. 4-11, the infeed lift 30 is aligned with the right stacked rack 22R of the storage rack 14 and the outfeed lift 32 is aligned with the left stacked rack 22L of the storage rack 14. The infeed lift 30 is dedicated to only inbound items and the outfeed lift 32 is dedicated to only outbound items, i.e. the infeed lift 30 and outfeed lift 32 are each configured to move items in only one horizontal direction. For example, the infeed lift 30 in the left side lift system 12L can only move items from the lift platform toward the left side rack module 14L.

A primary buffer portion or module 37 is disposed between each transfer lift system 12 and the corresponding storage rack module 14, the primary buffer portion 37 facilitates item transfers between the lift system 12 and the rack module 14 (FIGS. 4-11). In the illustrated embodiment of FIGS. 4-15, for each of the left side storage rack module 14L and the right side storage rack module 14R, the primary buffer portion 37 includes an infeed buffer or standby rack conveyor 38 at each level 18 of the right stacked rack 22R adjacent the infeed lift 30, and an outfeed buffer or standby rack conveyor 40 at each level 18 of the left stacked rack 22L adjacent the outfeed lift 32. The infeed rack conveyors 38 receive items from the infeed lift 30 and buffer the items until they are retrieved by the shuttle 26 in that level 18. The outfeed rack conveyors 40 receive items from the shuttle 26 in that level and buffer the items until they are retrieved by the outfeed lift 32 at that level 18. The infeed rack conveyors 38 are dedicated to only inbound items and the outfeed rack conveyors 40 are dedicated to only outbound items, i.e. the infeed rack conveyors 38 and outfeed rack conveyors 40 are each configured to move items in only one horizontal direction. For example, the infeed rack conveyors 38 in the left side storage rack module 14L can only move items from the infeed lift 30 platform into the left side rack module 14L. A number of types and forms can be considered for the buffer rack conveyors, but a conveyor which allows the package to be loaded on or off in the direction perpendicular to the direction of conveyance is desirable (e.g. a roller conveyor).

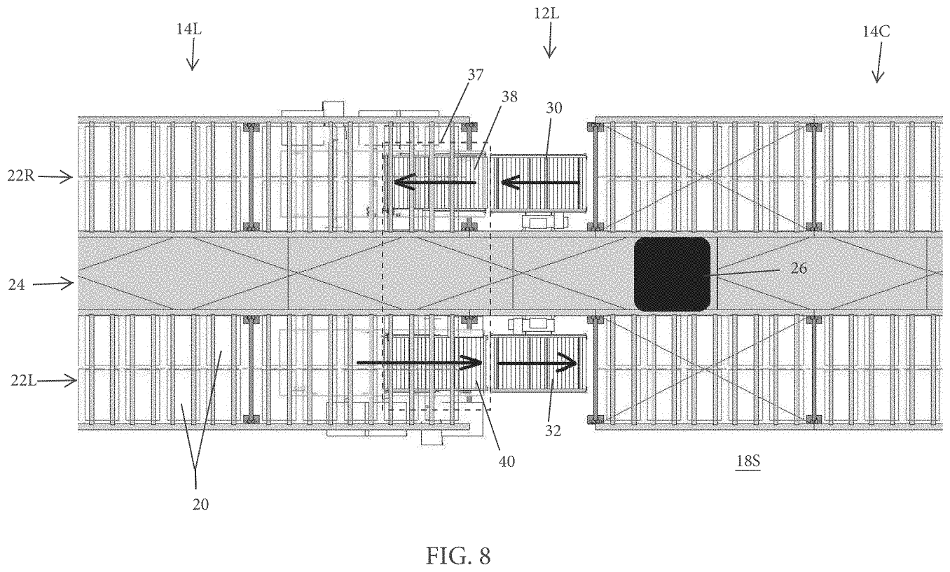

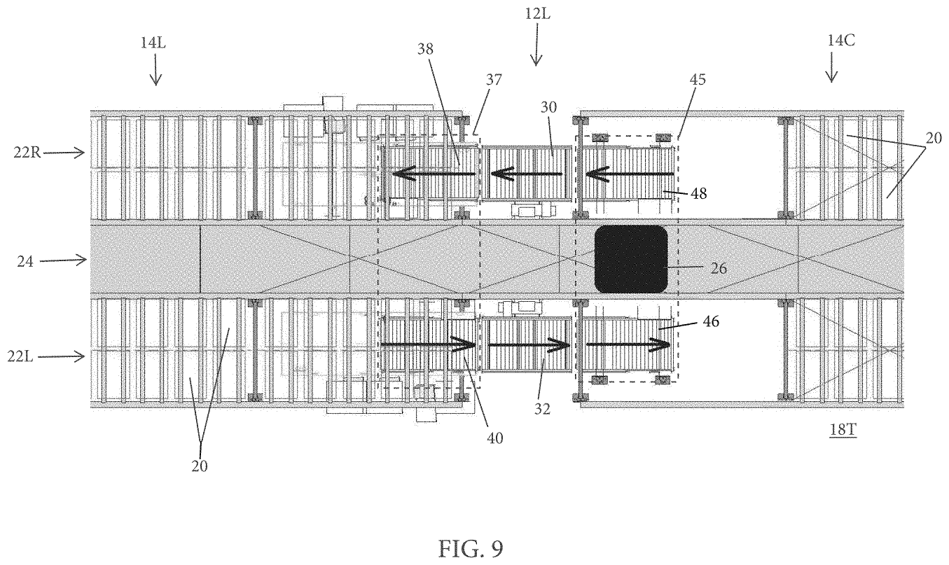

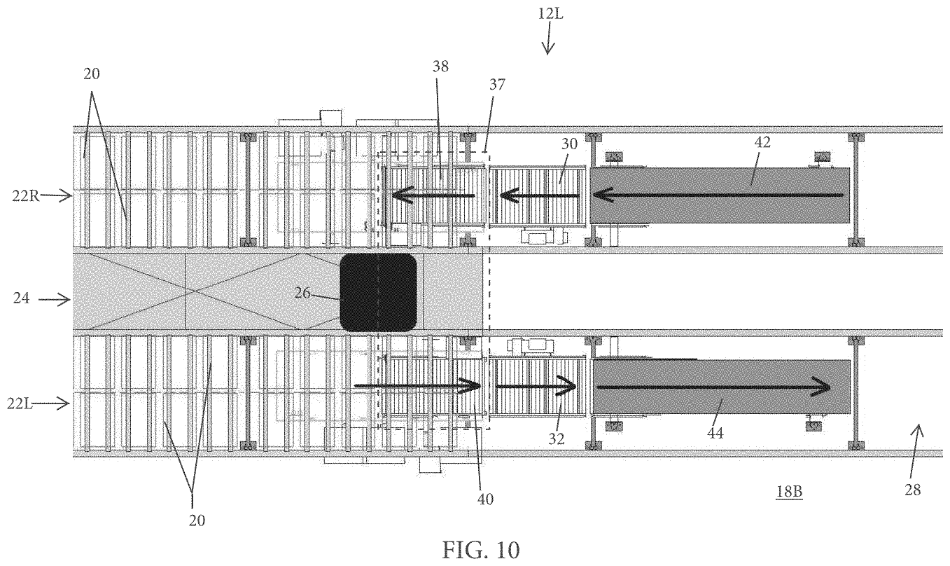

The storage facility 10 includes three types of rack levels 18 to facilitate the effective transportation of items, including standard levels 18S, transfer levels 18T, and basement levels 18B (FIGS. 4-6, 8-11). Shuttles 26 disposed in the standard levels 18S are capable of moving throughout all of the corresponding storage rack modules 14L, 14R, and 14C to retrieve products from any of the item storage locations 20 within that particular standard level 18S (FIGS. 4 and 8). Shuttles 26 disposed in the transfer levels 18T are capable of moving throughout all of the corresponding storage racks 14L, 14R, and 14C to retrieve products from any of the item storage locations 20 within that particular transfer level 18T (FIGS. 4 and 9). Shuttles 26 disposed within the basement levels 18B of the left rack module 14L are confined to operation only within rack module 14L and shuttles 26 disposed within the basement levels 18B of the right rack module 14R are confined to operation only within rack module 14R (FIGS. 4 and 10).

Each transfer level 18T includes a transfer buffer portion or module 45 including a pair of transfer buffer conveyors disposed at each end of each level of the intermediate rack module 14C to either receive an item from an outfeed lift 32 or to transfer an item to an infeed lift 30 (FIGS. 4-6 and 9). The transfer buffer module 45 includes an infeed transfer buffer conveyor 46 (FIG. 9) adjacent to the outfeed lift 32 at each end of the left stacked rack 22L at each transfer level 18T within the intermediate rack module 14C. The infeed transfer conveyor 46 receives an item from the outfeed lift 32 and buffers the item until a shuttle 26 within that transfer level 18T retrieves it from the transfer conveyor 46 (FIG. 9). The transfer buffer module 45 includes an outfeed transfer conveyor 48 (FIG. 9) adjacent to the infeed lift 30 at each end of each transfer level 18T within the intermediate rack module 14C. The outfeed transfer conveyor 48 receives an item from a shuttle 26 within that transfer level 18T and buffers the item until it is transferred to the infeed lift 30. The standard levels 18S and basement levels 18B do not include transfer conveyors 46 or 48. A number of types and forms can be considered for the transfer conveyors 46, 48, but a conveyor which allows the package to be loaded on or off in the direction perpendicular to the direction of conveyance is desirable (e.g. a roller conveyor).

The shuttles 26 are adapted to receive items from or supply items to the buffer conveyors within the corresponding level 18. For standard levels 18S, the shuttles 26 are adapted to receive items from any of the rack conveyors 38, 40 corresponding to that particular level in any of the rack modules 14L, 14C, 14R. For the transfer levels 18T, the shuttles 26 are adapted to receive items from or supply items to any of the buffer rack conveyors 38, 40 and the transfer conveyors 46, 48 corresponding to that particular level in any of the rack modules 14L, 14C, 14R. For the basement levels 18B, the shuttles 26 are adapted to receive items from or supply items to any of the buffer rack conveyors 38, 40 within the particular rack module 14L or 14R in which the shuttle 26 is disposed. The transfer conveyors 46, 48 and the shuttles 26 in the transfer levels 18T cooperate to transfer an item from either lift system 12L or 12R to the other lift system. Because the shuttles 26 can service any storage location 20 within the corresponding standard level 18S, no transfer conveyors 46, 48 are provided within the standard levels 18S in the intermediate rack module 14C. As such, the shuttles 26 within the standard levels 18S can transfer items from one lift system 12L or 12R to the other lift system.

Shuttles within basement levels 18B are not capable of transferring items to disparate lift systems and doing so requires the use of the adjacent lift system 12 and a transfer level 18T. The transfer functionality of the transfer levels 18T enables an item stored at a storage location 20 within a basement level 18B of the left rack module 14L or the right rack module 14R to be transferred to the lift system 12 that is disparate or non-adjacent to that rack module. For example, an item stored in one of the basement levels 18B of the left storage rack module 14L can be transported via shuttle 26 to the outfeed lift 12L adjacent to that rack module 14L. From there the outfeed lift 12L can transfer the item to an infeed transfer conveyor 46 at one of the transfer levels 18T. A shuttle 26 operating in that particular transfer level 18T can retrieve the item from that infeed transfer conveyor 46 and transport it anywhere along the aisle 24 corresponding to that transfer level 18T. As an example, if the item retrieved from the basement level 18B of the left rack module 14L is required at a packing station corresponding to the right side lift system 12R, the shuttle 26 transfers the item to the outfeed buffer rack conveyor 40 adjacent to the outfeed lift 32 in the right side lift system 12R. The item is buffered by the outfeed rack conveyor 40 until it is retrieved by that outfeed lift 32. The outfeed lift 32 then transfers the item to the outbound transportation system 36 that is in communication with the required packing station. It will be appreciated that this process can be adapted to transfer an item from any storage location 20 within the storage rack 14 to any lift system 12 within the storage facility 10. As another example, if the item retrieved from the basement level 18B of the left rack module 14L needs to be transferred to a basement level 18B of the right rack module 14R, the shuttle 26 transfers the item to the outfeed transfer conveyor 48 adjacent to the infeed lift 30 in the right side lift system 12R. The item is buffered by the outfeed transfer conveyor 40 until it is retrieved by that infeed lift 30. The infeed lift 30 then transfers the item to an infeed rack conveyor 38 corresponding to one of the basement levels 18B of the right rack module 14R where it is buffered until the shuttle 26 within that basement level 18B retrieves the item. It will be appreciated that this process can be adapted to transfer an item from any storage location 20 within the storage rack 14 to any other storage location 20 within the storage facility 12.

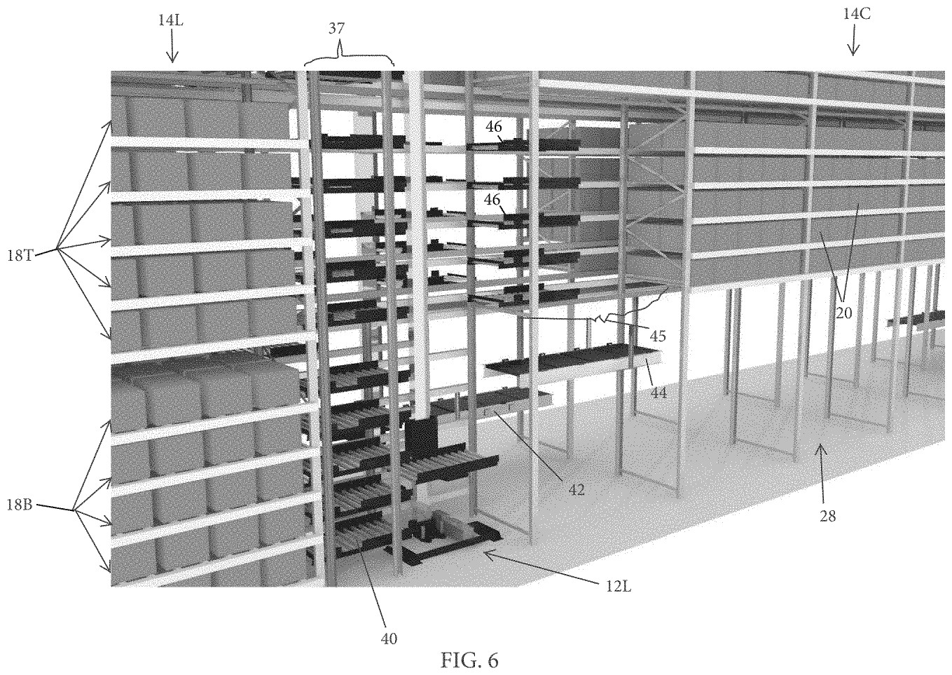

A pair of pick and drop conveyors 42, 44 are provided at respective locations adjacent to a corresponding lift system 12 (FIGS. 4-7, 10-11, and 13-15). The pair of pick and drop conveyors 42, 44 are positioned at ends of either the inbound transportation system 34 or the outbound transportation system 36, respectively. The outfeed pick conveyor 44 corresponds to the outbound transportation system 36, such that as an item is retrieved or picked from an item storage location it is then transferred to an outfeed lift 32 and then to the pick conveyor 44 to be transported via outbound transportation system 36 (FIG. 12). The infeed drop conveyor 42 corresponds to the inbound transportation system 34, such that as an item is transported to the storage rack 14 it is transferred from the inbound transport system 34 (FIG. 12) to the drop conveyor 42 and then to the infeed lift 30 to be introduced into the storage rack 14. The pick conveyor 44 and drop conveyor 42 may be disposed at the same level 18 of the storage rack 14. However, it is preferable, for space usage optimization, that the pick conveyor 44 is provided at one level 18 and the drop conveyor 42 is provided at a different one of levels 18. For example, the pick conveyor 42 may be positioned adjacent to one of the basement levels 18B and the drop conveyor 44 may be positioned adjacent to a different one of the basements levels 18B, as best shown in FIGS. 4 and 6.

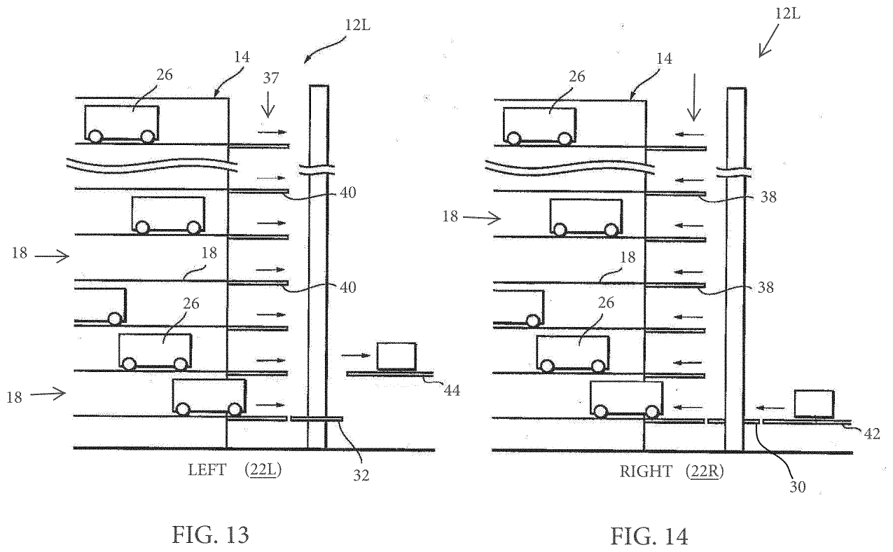

Referring to the illustrative embodiments of FIGS. 13 and 14, a left stacked rack 22L of a storage rack 14 is positioned adjacent to an outfeed lift 32 and an outbound/pick conveyor 44 is positioned adjacent to the outfeed lift 32. A right stacked rack 22R of a storage rack 14 is positioned adjacent to an infeed lift 30 and an inbound/drop conveyor 44 is positioned adjacent to the infeed lift 30.

Referring now to the illustrated embodiment of FIG. 1, a method 100 is provided for storing and/or retrieving items to/from an automated warehouse storage facility. If an item is being stored into the storage facility 10 (FIGS. 4 and 12) for storage at a particular item storage location 20, the method 100 includes delivering 102 an item with an inbound transport system 34 to an infeed drop conveyor 42 adjacent to a lift system 12 corresponding to the storage rack 14 where the item is required for storage. The method 100 includes transferring 104 the item to an infeed lift 30 adjacent to the infeed drop conveyor 42 and determining 105 whether the infeed lift 30 is in direct transport communication with the required item storage location 20. If it is determined that the infeed lift 30 is not in direct transport communication with the required item storage location 20, then transporting 107 the item with the infeed lift 30 to a transfer level 18T to be transferred to a lift that is in direct transport communication with the required item storage location 20. If the infeed lift 30 is in direct transport communication with the required item storage location 20, then moving 106 the item with the infeed lift 30 to the level 18 where the item is required. Then transferring 108 the item to an infeed buffer rack conveyor 38 at that required level 18, where the item may be buffered until a shuttle 26 is available to retrieve it. When available, the shuttle retrieving 110 the item from the infeed buffer rack conveyor 38 and transporting 112 the item to the required destination item storage location 20 for storage.

In the illustrated embodiment of FIG. 1, if an item already stored inside a storage rack 14 in the storage facility 10 (FIGS. 4 and 12) requires retrieval, the method 100 includes retrieving 114 the item from the item's storage location 20 with a shuttle 26 that is available to service that item storage location 20. Then transporting 116 the item with that shuttle 26 to an outfeed rack conveyor 40 corresponding to that level 18, where the item may be buffered until the adjacent outfeed lift 32 is available to retrieve it. The method 100 includes transferring 118 the item from the outfeed rack conveyor 40 to the outfeed lift 32 and then determining 119 if the outfeed lift is enabled to service the required destination location for the item, such as another item storage location 20 within the storage rack 14 or a packing station in transport communication with an outbound transportation system 36. If it is determined at 119 that the outfeed lift 32 is able to service the required destination location (i.e. the outfeed lift 32 is in direct transport communication with that required destination location), then moving (i.e. raising or lowering) and transferring 120 the item to an outfeed pick conveyor 44 adjacent to the outfeed lift 32. Then transferring 122 the item from the outfeed pick conveyor 44 to an outbound transportation system 36 that is in direct communication with the required destination location of the retrieved item. If it is determined at 119 that the outfeed lift 32 is not able to service the required destination location (i.e. the outfeed lift 32 is not in direct transport communication with that required destination location), then transporting 121 the item with the outfeed lift 32 to a transfer level 18T to be transferred to a lift that is in direct transport communication with the required destination location for the item. Method 100 is especially useful for maximizing space usage within the storage facility 10 wherein the infeed drop conveyor 42 and the outfeed pick conveyor 44 are disposed at different vertical heights relative to one another. The height of each conveyor 42 and 44 corresponding to a different level 18 of the storage rack 14, as depicted in the illustrated embodiments of FIGS. 4 and 6.

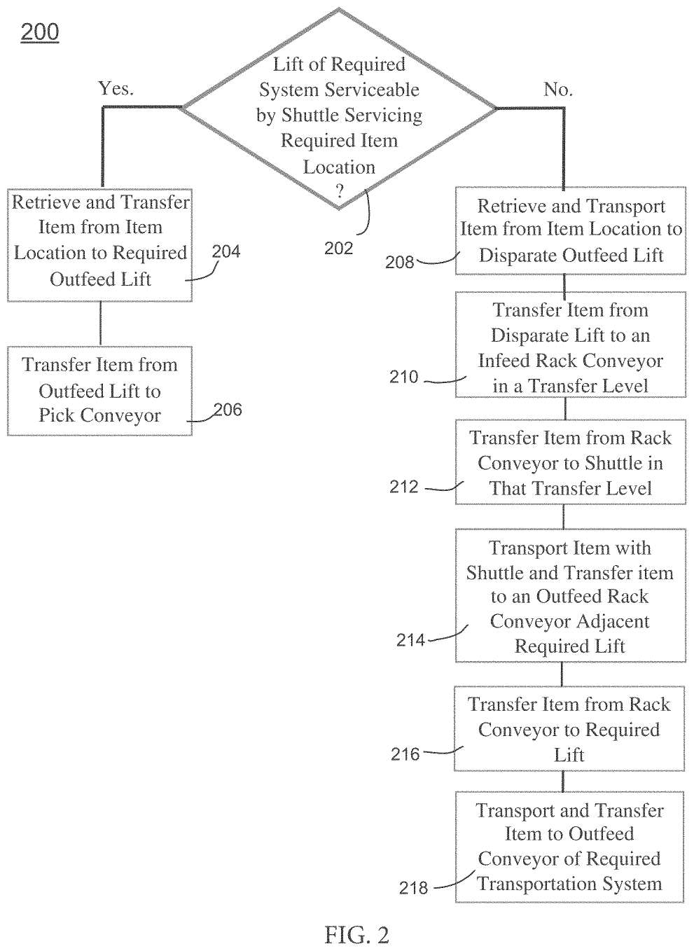

Referring now to the illustrated embodiment of FIG. 2, a method 200 is provided for operating an automatic warehouse storage facility 10 and includes determining 202 the accessibility of an item or product that is required at a specific destination location in the facility 10 to determine if that item is retrievable by a shuttle 26 that services an outfeed lift 32 that is in direct transport communication with that specific location. If it is determined at 202 that the outfeed lift 32 that is in direct communication with the specific destination location in the facility 10 is accessible by a shuttle 26 that services that outfeed lift 32, then the shuttle 26 retrieves that item and transfers 204 it to that particular outfeed lift 32. The item is then moved (i.e. raised or lowered) and transferred 206 from that outfeed lift 32 to a corresponding outfeed pick conveyor 44 and into the corresponding outbound transportation system 36 to be transported to the required destination location within the storage facility 12.

If it is determined at 202 that the outfeed lift 32 that is in direct transport communication with the specific item destination location in the facility 10 is not accessible by a shuttle 26 that services that outfeed lift 32, then the shuttle 26 that services the particular storage location 20 where the required item is stored retrieves the item and transfers 208 the required item from that shuttle 26 to an outfeed lift 32 in direct communication with that shuttle 26 corresponding to that particular storage location 20 (FIG. 2). The method 200 includes transporting 210 the required item with that outfeed lift 32 to an infeed transfer conveyor 46 at a transfer level 18T adjacent to that outfeed lift 32. Then retrieving 212 the item from the transfer conveyor 46 with a shuttle 26 in that transfer level 18T. The shuttle 26 in the transfer level 18T transports and transfers 214 the item to an outfeed transfer conveyor 48 adjacent to the outfeed lift 32 that is in direct communication with the outbound transportation system 36 corresponding to the item's required location in the storage facility 12. Then transferring 216 the item from the outfeed transfer conveyor 48 to that outfeed lift 32 and then moving (i.e. raising or lowering) and transferring 218 the item with that outfeed lift 32 to a level 18 corresponding to an outfeed pick conveyor 44 adjacent to the particular outbound transportation system 36 that requires the required item.

The method 200 of the illustrated embodiment of FIG. 2 is particularly useful for servicing disparate storage rack modules (e.g. disparate rack modules 14L, 14R of the illustrative embodiment of FIGS. 4 and 12) with a particular lift that is not adjacent to the particular storage rack that requires service and therefore not directly serviceable by that particular lift. As an example, the right lift system 12R is disparate from left rack module 14L because lift system 12R cannot service all levels of the left rack module 14L because the shuttles 26 in the basement levels 18B of left rack module 14L cannot travel to the right lift system 12R. The shuttles 26 in in the basement levels 18B of left rack module 14L are therefore not in direct communication with the right lift system 12R.

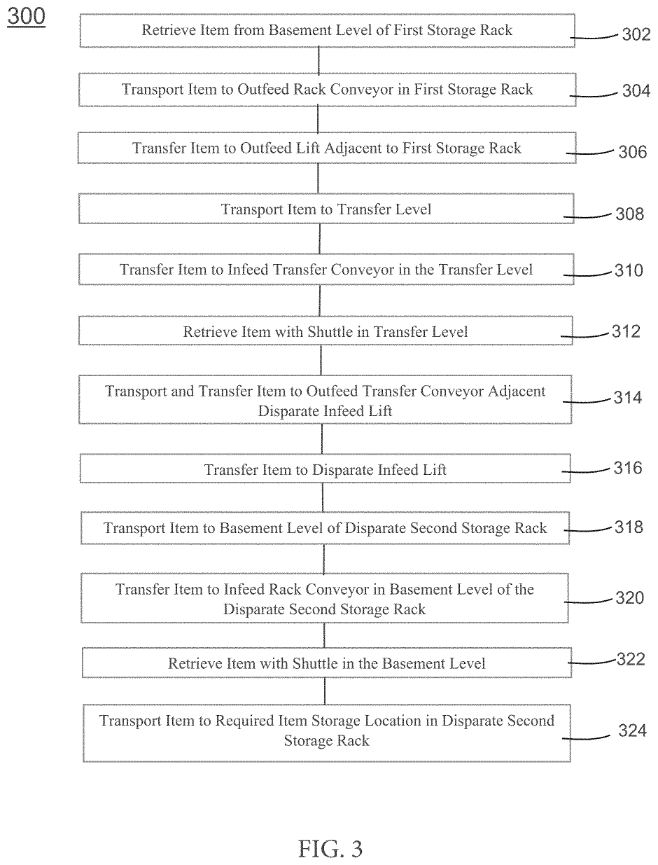

In the illustrated embodiment of FIG. 3, a method 300 is provided for transferring a required item from an original item storage location 20 in a basement level 18B of a storage rack module 14 (e.g. left rack module 14L, see FIG. 4) to a destination item storage location 20 in a basement level 18B of another disparate storage rack module 14 that is disparate from the original rack module (e.g. right rack module 14R, see FIG. 4). Method 300 includes retrieving 302 an item from an item storage location 20 with a shuttle 26 in a basement level 18B of the left storage rack module 14L and transporting 304 that item with the shuttle 26 to an outfeed buffer rack conveyor 40 of that basement level 18B corresponding to the required item, where the item may be buffered until the adjacent outfeed lift 32 is available to retrieve it. Then transferring 306 the item from the outfeed rack conveyor 40 to the adjacent outfeed lift 32 in the left side lift system 12L. The method 300 includes transporting 308 the item with the outfeed lift 32 of the left lift system 12L to an available transfer level 18T of an intermediate storage rack module 14C and then transferring 310 the item from that outfeed lift 32 to an infeed transfer conveyor 46 corresponding to the available transfer level 18T. The item may be buffered at the infeed transfer conveyor 46 until a shuttle 26 disposed within that transfer level 18T is available to retrieve it.

Method 300 includes retrieving 312 the item with the shuttle 26 from the infeed transfer conveyor 46 and transporting and transferring 314 the item to an outfeed transfer conveyor 48 adjacent to an infeed lift 30 corresponding to the right side lift system 12R (FIG. 3). The item may be buffered at the outfeed transfer conveyor 48 until the corresponding infeed lift 30 is available to receive it. When the infeed lift 30 is available, transferring 316 the item from the outfeed transfer conveyor 48 to the infeed lift 32 of the right lift system 12R. The method 300 includes transporting 318 the item to an infeed buffer rack conveyor 38 corresponding to a basement level 18B of the disparate right storage rack module 14R. Then, transferring 320 the item from the infeed lift 32 of the right lift system 12R to the infeed buffer rack conveyor 38, where the item may be buffered until the shuttle 26 within that basement level 18B is available to retrieve it. Method 300 includes retrieving 322 the item with the shuttle 26 in that basement level 18B from the infeed rack conveyor 38 and then transporting 324 the item to the required item storage location in that basement level 18B of the right rack module 14R. It will be appreciated that this method 300 can be adapted to transfer an item from any storage location 20 in one storage rack 14 to any other storage location 20 within the storage facility 12.

Thus, the system and methods of the illustrated embodiments provide an efficient inter-level transfer to transfer items from one item storage location in a storage facility to another location in the storage facility, including either a different item storage location or to an outbound transportation system such as for transporting the item to a packing station. The methods and system are particularly useful for transferring items between locations that are not in direct transport communication with one another, such that multiple transportation components are required to transport the item. The system includes an inbound drop conveyor, an infeed lift, and an infeed conveyor module cooperating to input items into the storage rack and the system includes an outbound pick conveyor, an outfeed lift, and an outfeed conveyor module cooperating to retrieve items from the storage rack. The system also includes transfer modules at particular levels of the storage racks that cooperate with the outfeed lifts to transfer items from one portion of the storage facility to another portion of the storage facility to enable efficient transport of items to required locations in the storage facility. The inbound drop conveyor and the outbound drop conveyor are preferably disposed at different vertical levels of the storage rack such that empty space or “basement” required within the storage rack is minimized, thereby reducing conflicts and optimizing available storage space to increase efficiency and through-put within the storage facility.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. A method for storing goods into and retrieving goods from an automated warehouse storage facility having a plurality of storage rack levels, a storage and retrieval shuttle at each storage rack level, an item infeed conveyor adapted to induct goods to an infeed lift that is configured to move and transfer items to a particular one of the storage rack levels to be stored into the storage facility, and an outfeed lift configured to move and transfer items from one of the levels of the storage facility to an item outfeed conveyor that is configured to transfer the items to an outbound transportation system, said method comprising:
determining if an item is to be stored into the storage facility or retrieved from the storage facility;
if the item is to be stored, said method comprising:
delivering the item to the infeed conveyor with an inbound transportation system;
transferring the item from the infeed conveyor to the infeed lift, wherein the infeed lift is configured to move items in one horizontal direction away from the infeed conveyor; and
moving and transferring the item with the infeed lift to a particular storage rack level to be stored at a required item storage location in that particular level; and
if the item is to be retrieved, said method comprising:
retrieving the item from the item's storage location within the storage facility;
transporting the item from the item storage location to the outfeed lift, wherein the outfeed lift is configured to move items in one horizontal direction towards the outfeed conveyor;
moving and transferring the item with the outfeed lift to the outfeed conveyor; and
transferring the item from the outfeed conveyor to the outbound transportation system.

2. The method of claim 1, wherein the infeed conveyor and the outfeed conveyor are disposed at different storage rack levels.

3. The method of claim 1, further comprising determining whether the infeed lift is able to service the required storage location for the item being stored, if it is determined that the infeed lift is able to service the required storage location, moving and transferring the item with the infeed lift to the particular storage rack level having the required item storage location, if it is determined that the infeed lift is not able to service the required item storage location, moving and transferring the item to another lift that is able to service the required item storage location.

4. The method of claim 1, further comprising, after transporting the item from the item storage location to the outfeed lift, determining if the item is required at another item storage location within the storage facility or at an outbound transportation system, if the item is required at another item storage location within the storage facility, transporting the item to the another item storage location, and if the item is required at an outbound transportation system, moving and transferring the item with the outfeed lift to the outfeed conveyor.

5. The method of claim 1, if the item is to be retrieved, said method further comprising:
determining if the shuttle and the outfeed lift servicing the particular storage location of the required item are in direct transport communication with a particular outbound transportation system that requires the required item;
if it is determined that the shuttle and lift servicing the required item's storage location are in direct transport communication with the particular outbound transportation system that requires the required item:
retrieving the required item with the shuttle from the particular storage location;
transporting the required item with that shuttle to the lift servicing the particular outbound transportation system that requires the required item; and
transferring the required item with that lift to the particular outbound transportation system that requires the required item;
and
if it is determined that the shuttle and lift servicing the required item's storage location are not in direct transport communication with the particular outbound transportation system that requires the required item, performing an inter-level transfer with an inter-level transfer system, said performing an inter-level transfer comprises:
retrieving the required item with an initial shuttle from the particular storage location;
transferring the required item from the initial shuttle to an initial lift that is in direct transport communication with the initial shuttle;
moving the required item with the initial lift to an intermediate shuttle that is configured to service both the initial lift and a required lift that is in direct transport communication with the particular outbound transportation system that requires the required item;
transporting the required item with the intermediate shuttle to the required lift;
transferring the required item from the intermediate shuttle to that required lift;
moving the item with that required lift to the particular outbound transportation system that requires the required item; and
transferring the required item from that required lift to the particular outbound transportation system that requires the required item.

6. The method of claim 1, wherein said retrieving an item from the item's storage location includes retrieving the item with a shuttle adapted to retrieve items from item storage locations within the respective storage rack level corresponding to the shuttle.

7. The method of claim 6, wherein said transporting the item to the outfeed lift includes transporting the item with the shuttle to a buffer conveyor adjacent to the outfeed lift, buffering the item until the outfeed lift is ready to retrieve the item, and when the outfeed lift is ready, retrieving the item with the outfeed lift from the buffer conveyor.

8. A method for transferring goods with an inter-level transfer system from a particular item storage location at a level of a first portion of a storage rack system to a level of second portion of the storage rack system which is disparate from the first portion of the storage rack system, said method for transferring goods with an inter-level transfer system comprising:
retrieving an item from an initial level of a first storage rack that is serviceable by a first lift disposed adjacent to the first storage rack;
transporting the item from the initial level to the first lift;
moving the item with the first lift to an intermediate level of the storage rack, wherein the intermediate level is disposed in an intermediate portion of the storage rack system between the first portion and a second portion of the storage rack system, the intermediate level configured to transfer an item from the first lift to a second lift disposed adjacent to the second portion of the storage system at an opposite side of the intermediate portion from the first portion;
transporting the item via the intermediate level from the first lift to the second lift;
transferring the item from the intermediate level to the second lift; and
moving the item with the second lift to a destination level of the second portion of the storage rack;
wherein the initial level of the first storage rack is not directly serviceable by the second lift and the destination level of the second portion of the storage rack system is not directly serviceable by the first lift.

9. An automated warehouse storage facility comprising:
a storage rack module comprising a plurality of levels each having a plurality of item storage locations, said storage rack module having a first side storage rack, a second side storage rack spaced apart from said first side storage rack, and an aisle disposed at each level between said first and second storage racks;
a shuttle disposed in said aisle of each level, said shuttle adapted to service said plurality of item storage locations of the level corresponding to said shuttle;
an infeed lift adjacent to said first side storage rack and configured for inputting items into said storage rack module;
an outfeed lift adjacent to said second side storage rack and configured for retrieving items from said storage rack module;
an infeed rack conveyor disposed at each level of said first side storage rack between said first side storage rack and said infeed lift, wherein said infeed rack conveyor is configured to receive items from said infeed lift and to buffer the items until said shuttle disposed in said aisle of the respective level is available to retrieve the item; and
an outfeed rack conveyor disposed at each level of said second side storage rack between said second side storage rack and said outfeed lift, wherein said outfeed rack conveyor is configured to receive items from said shuttle disposed in said aisle of the respective level and to buffer the items until said outfeed lift is available to retrieve the item;
wherein said infeed rack conveyor and said shuttle disposed at each level cooperate with said infeed lift to input items into said storage rack module;
wherein said outfeed rack conveyor and said shuttle disposed at each level cooperate with said outfeed lift to retrieve items from said storage rack module.

10. The automated warehouse storage facility of claim 9, further comprising an infeed drop conveyor disposed adjacent to said infeed lift and configured to transfer items from an inbound transportation system to said infeed lift, and an outfeed pick conveyor disposed adjacent to said outfeed lift and configured to transfer items from said outfeed lift to an outbound transportation system, wherein said infeed drop conveyor is vertically positioned at one of said levels of said storage rack module and said outfeed pick conveyor is vertically positioned at a different one of said levels of said storage rack module such that said infeed drop conveyor and said outfeed pick conveyor are vertically offset from one another by at least one level of said storage rack module.
